(19) United States
(12) Patent Application Publication
(10) Pub. No.: US 2025/0361828 A1
(43) Pub. Date: Nov. 27, 2025

(54) AFTERTREATMENT FOR ALCOHOL FUEL SUBSTITUTED DIESEL ENGINES USING AN OXIDATION-ENABLED SELECTIVE CATALYST REACTOR

(71) Applicant: Caterpillar Inc., Peoria, IL (US)

(72) Inventors: Joshua Lynn Ratts, Pine Village, IN (US); Eric Lee Schroeder, Germantown Hills, IL (US); Michael Bardell, Peoria, IL (US)

(73) Assignee: Caterpillar Inc., Peoria, IL (US)

(21) Appl. No.: 18/674,353

(22) Filed: May 24, 2024

(51) Int. Cl. F01N 13/00; F01N 3/10; F01N 3/20

(52) U.S. Cl. CPC F01N 13/0097; F01N 3/103; F01N 3/2066; F01N 2370/04

(57) ABSTRACT

An internal combustion engine system is described herein. The system uses an oxidation-enabled selective catalyst reactor (SCR) to treat NOx emissions and secondary exhaust components in an exhaust of the internal combustion engine. The oxidation-enabled SCR includes at least two stages: an NOx reduction stage having NOx reduction matrix configured to react with and reduce an amount of the NO2 and/or NO in the exhaust of the internal combustion engine; and an oxidation stage having an oxidation catalyst configured to oxidize at least a portion of the secondary exhaust components. The oxidation stage can be coated onto the NOx reduction matrix or may be substituted in for portions of the NOx reduction matrix.

### TECHNICAL FIELD

The present disclosure relates to an exhaust aftertreatment system for treating exhaust gases from an internal combustion engine and, more particularly, to a system and method of utilizing an oxidation selective catalyst reactor to oxidize unburned hydrocarbons and formaldehyde to desired levels.

### BACKGROUND

Internal combustion engines are widely used in various industries. Internal combustion engines can operate on a variety of different liquid fuels, gaseous fuels, and various blends. Spark-ignited engines employ an electrical spark to initiate combustion of fuel and air, whereas compression ignition engines typically compress gases in a cylinder to an autoignition threshold such that ignition of fuel begins without requiring a spark. In an attempt to reduce greenhouse gases (GHG), some endeavors have been made to change the primary fuel used in combustions engines from fuels such as diesel to alcohol fuels such as ethanol and methanol, or combinations of these fuels. The alcohol fuels can be introduced into a combustion chamber in various ways. For example, methanol may be introduced into an inlet airstream through the intake air manifold of an engine. This type of injection is sometimes referred to as “port fuel injection.” Direct fuel injection (DFI) systems use an injector that injects the alcohol directly into the combustion chamber. While sometimes more complex than port fuel injection systems, when properly configured, direct fuel injection systems can burn fuel cleaner, sometime resulting in exhaust products similar to non-alcohol systems such as a diesel-only systems.

In some combustion engines, the exhaust often includes various ratios of nitrogen dioxide (NO2) to nitric oxide (NO). When alcohol-based fuels, or other oxygenated fuels, are used with diesel fuels, the amount of nitrogen dioxide (NO2) can significantly increase. NO2 can be considered a pollutant due to its effect on humans. Further, NO2 can contribute to the formation and modification of other pollutants such as ozone, particulate matter, as well as acid rain. Some efforts have been made to reduce the amount of NO2 produced in a diesel engine that uses an alcohol fuel, such as methanol. For example, U.S. Pat. No. 11,143,078 to Moore et. al (“the '078 patent”) describes one such effort. The '078 patent describes the use of a closely coupled SCR catalyst and a primary SCR catalyst. The closely coupled SCR catalyst is used during low load conditions, whereas the primary SCR catalyst is used during loaded conditions. However, the system (and process) described in the '078 patent suffers from some shortfalls. For example, the system of the '078 patent uses a second SCR catalyst (the closely coupled SCR catalyst), thus requiring additional components. Additionally, the SCR catalyst and the primary SCR catalyst are used for the reduction of NOx in the exhaust gas. Remaining unburned alcohol fuel may not be treated and may be released, at least partially, into the atmosphere.

Some examples of the present disclosure are directed to overcoming these and other deficiencies of such systems.

### SUMMARY

In an aspect of the present disclosure, an internal combustion engine system includes an internal combustion engine configured to combust diesel fuel and a secondary fuel using a direct fuel injector to inject the diesel fuel and the secondary fuel into a cylinder of the internal combustion engine, wherein a portion of an exhaust of the combustion engine comprises nitrogen dioxide (NO2), nitric oxide (NO), and secondary exhaust components, wherein at least a portion of the secondary exhaust components comprise uncombusted secondary fuel, an oxidation-enabled selective catalyst reactor (SCR) comprising a NOx reduction stage comprising an NOx reduction matrix configured to react with and reduce an amount of the NO and NO2 in the exhaust of the internal combustion engine, and an oxidation stage comprising an oxidation catalyst configured to oxidize and reduce at least a portion of the secondary exhaust components in the exhaust to generate treated exhaust.

In another aspect of the present disclosure, an oxidation-enabled selective catalyst reactor (SCR) for treating an exhaust of an internal combustion engine using a direct fuel injector to inject a primary fuel and a secondary fuel into a cylinder of the internal combustion engine includes a NOx reduction stage comprising an NOx reduction matrix configured to react with and reduce an amount of NO2 and NO in an exhaust of the internal combustion engine, and an oxidation stage comprising an oxidation catalyst configured to oxidize and reduce at least a portion of secondary exhaust components in the exhaust to generate treated exhaust.

In a still further aspect of the present disclosure, a method of controlling emissions in an exhaust of an internal combustion engine using a direct fuel injector includes directing at least a portion of the exhaust into an NOx reduction stage of an oxidation-enabled selective catalyst reactor (SCR), the NOx reduction stage comprising an NOx reduction matrix configured to react with and reduce an amount of NO2 or NO in the exhaust of the internal combustion engine, and directing the at least a portion of the exhaust into an oxidation stage of the oxidation-enabled SCR, the oxidation stage comprising an oxidation catalyst configured to oxidize and reduce at least a portion of secondary exhaust components in the at least a portion of the exhaust to generate treated exhaust.

### BRIEF DESCRIPTION OF DRAWINGS

FIG. 1 illustrates an internal combustion engine system configured to control emissions using an oxidation-enabled selective catalyst reactor, in accordance with various embodiments of the presently disclosed subject matter.

FIG. 2 illustrates a direct fuel injector that may be used in a combustion engine system configured to control emissions, in accordance with various embodiments of the presently disclosed subject matter.

FIG. 3 is a side-view, cutaway illustration of an oxidation-enabled selective catalyst reactor having a catalyst tube with an oxidation layer used to oxidize secondary exhaust components, in accordance with various examples of the presently disclosed subject matter.

FIG. 4 is a cross-sectional view of a catalyst tube with an oxidation layer used to oxidize secondary exhaust components, in accordance with various examples of the presently disclosed subject matter.

FIG. 5 is a method of using an oxidation-enabled selective catalyst reactor having a catalyst tube with an oxidation stage used to oxidize secondary exhaust components, in accordance with various examples of the presently disclosed subject matter.

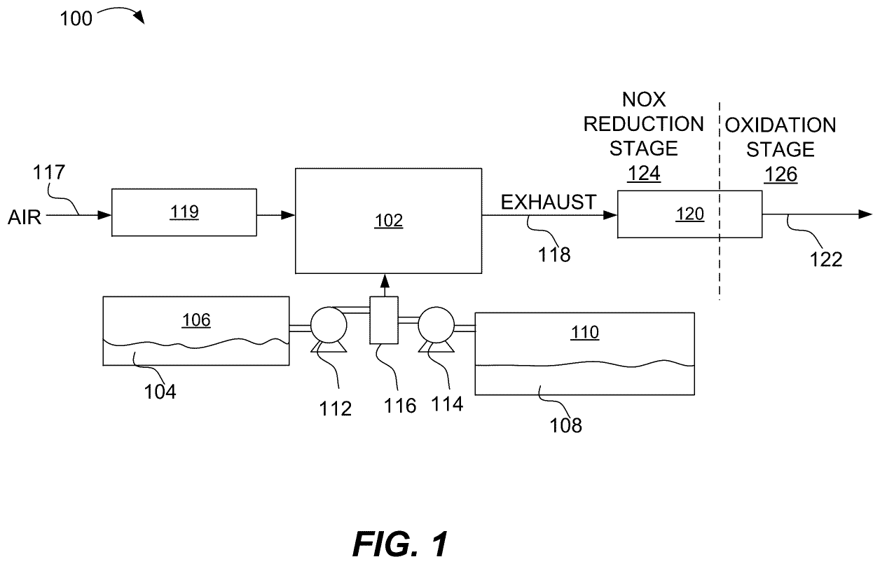

### DETAILED DESCRIPTION

Wherever possible, the same reference numbers will be used throughout the drawings to refer to the same or like parts. FIG. 1 illustrates an internal combustion engine system 100 configured to control emissions, in accordance with various embodiments of the presently disclosed subject matter. The internal combustion engine system 100 includes an internal combustion engine 102 with a plurality of combustion cylinders (not shown). The internal combustion engine 102 may have any number of combustion cylinders. It will be understood that the combustion cylinders are associated with a piston (not shown) movable between a top dead center position and a bottom dead center position in a generally conventional manner, typically in a four-stroke engine cycle, though other combustion cycles may be used and are considered to be within the scope of the presently disclosed subject matter. The pistons will be coupled with a crankshaft (not shown) rotatable to provide torque for purposes of vehicle propulsion, operating a generator for production of electrical energy, or in still other applications such as operating a compressor, a pump, or various other types of equipment.

The internal combustion engine 102 is fueled by a primary fuel 104 stored in a primary fuel tank 106 and a secondary fuel 108 stored in a secondary fuel tank 110. The primary fuel 104 may include a higher cetane/lower octane liquid fuel, and the secondary fuel 108 may include a lower cetane/higher octane liquid fuel. The terms “higher” and “lower” in this context may be understood as relative terms in relation to one another. Thus, the primary fuel 104 may have a higher cetane number and a lower octane number than a cetane number and an octane number of the secondary fuel 108. The primary fuel 104 might include a diesel distillate fuel, dimethyl ether, biodiesel, Hydrotreated Vegetable Oil (HVO), Gas to Liquid (GTL) renewable diesel, any of a variety of liquid fuels with a cetane enhancer, or still another fuel type. The secondary fuel 108 may include an alcohol fuel such as methanol or ethanol, for example, or still other fuel types such as, but not limited to, isopropyl alcohol, n-propyl alcohol, and t-butyl alcohol. For the purposes of FIG. 1, the primary fuel 104 is described as diesel fuel and the secondary fuel 108 is described as methanol, though as noted above, the presently disclosed subject matter may be used with other fuel types.

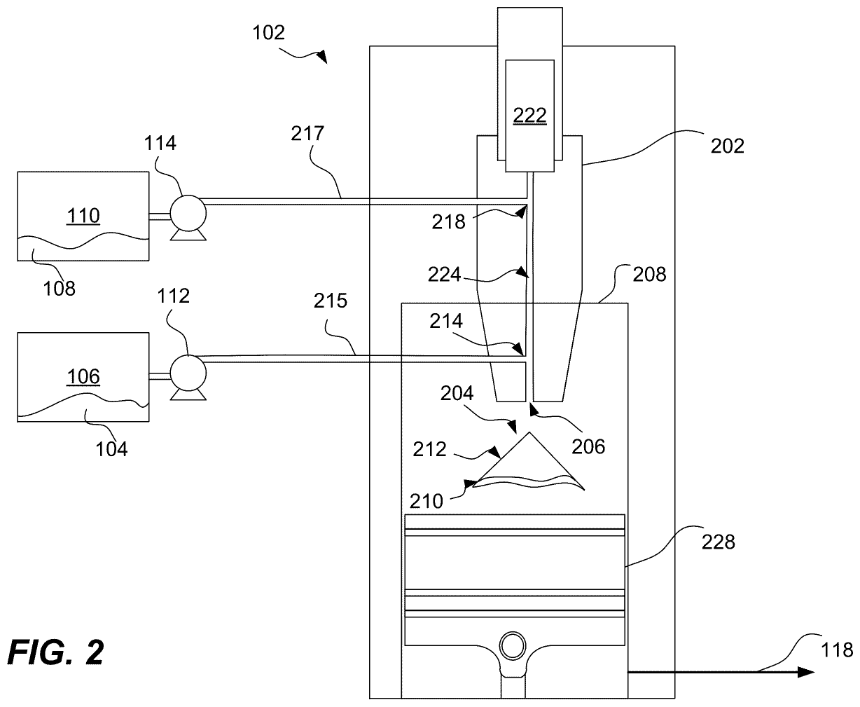

The primary fuel 104 may be delivered to the engine 102 by a primary fuel pump 112 in fluidic communication with the primary fuel tank 106. The secondary fuel 108 may be delivered to the engine 102 by a secondary fuel pump 114 in fluidic communication with the secondary fuel tank 110. Air 117 for combustion may be received through an air intake manifold 119. Using the primary fuel pump 112 and the secondary fuel pump 114, the primary fuel 104 and the secondary fuel 108 can be made available to a direct fuel injector 116 of the engine 102. The direct fuel injector 116 receives the primary fuel 104 and/or the secondary fuel 108 and injects the delivered fuel into a combustion chamber of the engine 102, described in FIG. 2.

FIG. 2 illustrates a direct fuel injector 202 that may be used in a combustion engine system configured to control emissions, in accordance with various embodiments of the presently disclosed subject matter. It should be noted that the injector 202 as illustrated in FIG. 2 is merely to illustrate example fluid flows using a direct fuel injector, as the injector 202 and other components illustrated herein may have additional features, components, or structures that are not illustrated in this and other figures but may otherwise be used. Further, the injector 202 is an example of a type of direct fuel injector that may be used, as other configurations and designs may be used, such as separate fuel injectors for the primary fuel and the secondary fuel, and are considered to be within the scope of the present disclosure. Returning to FIG. 2, the injector 202 injects a fuel load 204 through an injector port 206 into a cylinder 208 of the engine 102 for combustion. It should be noted that although one fuel injector 202 is illustrated, the presently disclosed subject matter may be used with other types of injectors, including injectors with separate ports for the primary fuel and the secondary fuel, and are considered to be within the scope of the presently disclosed subject matter.

The fuel load 204 includes a primary fuel portion 210 comprising the primary fuel 104 and a secondary fuel portion 212 comprising the secondary fuel 108. The primary fuel 104 is injected first to commence the combustion process in the cylinder 208, acting as a pilot fuel. The injector 202 includes a primary fuel inlet 214 for receiving the primary fuel 104 from a primary fuel input line 215. The injector 202 further includes a secondary fuel inlet 218 for receiving the secondary fuel 108 from a secondary fuel input line 217. To create the fuel load 204, the injector 202 includes a piston 222. The piston 222 is configured to create a vacuum in a first action to pull the primary fuel 104 and the secondary fuel 108 into an injection chamber 224 of the injector 202. The piston 222 then creates a pressure in a second action to push the primary fuel 104 and the secondary fuel 108 in the injection chamber 224 into the cylinder 208. In the example injector 202 illustrated in FIG. 2, the primary fuel 104 is injected first because of the lower position (i.e., fluidically closer to the injector port 206) of the primary fuel 104 in the chamber relative to the secondary fuel 108. The combustion of the fuel load 204 pushes down a cylinder piston 228, whereby the combustion products exit the cylinder 208 through an exhaust 118.

Referring back to FIG. 1, the treatment of the combustion products in the exhaust 118 is described further. In diesel fuel engines, “fuel NOx” in the exhaust 118 is formed by the oxidation of nitrogen in air at elevated combustion temperatures in a combustion cylinder during combustion. To reduce the amount of NOx in emissions from a diesel fuel engine, the internal combustion engine system 100 further includes an oxidation-enabled selective catalyst reactor (SCR) 120 to provide for a treated exhaust 122. The oxidation-enabled SCR 120 is made from various porous ceramic materials used as a support, such as titanium oxide, and active catalytic components are usually either oxides of base metals (such as vanadium, molybdenum, and tungsten), zeolites, or various precious metals. A reductant, such as but not limited to, anhydrous ammonia (NH3), aqueous ammonia (NH4OH), or a urea (CO(NH2)2) solution, is added to a stream of flue or exhaust gas and is reacted onto a catalyst. As the reaction drives toward completion, nitrogen (N2), and carbon dioxide (CO2), in the case of urea use, are produced. Based on the compounds entering the oxidation-enabled SCR 120 and their respective stoichiometric ratios, the reduction reaction in the oxidation-enabled SCR 120 proceeds at various. Equation #1, below, represents a slow rate of a reduction reaction when the entering reactants are in the stoichiometric ratios indicated in Equation #1. Equation #2, below, represents a standard rate of a reduction reaction when the entering reactants are in the stoichiometric ratios indicated in Equation #2. Equation #3, below, represents a fast rate of reduction (fast SCR) reaction when the entering reactants are in the stoichiometric ratios indicated in Equation #3.

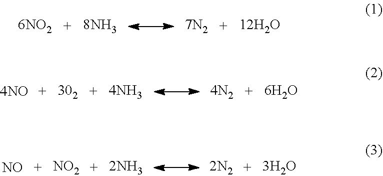

Because of the rate of the reduction reaction, in some examples, a stoichiometric ratio allowing for Equation #3 may be preferable. The optimal stoichiometric ratio to achieve Equation #3 is when NO is in a 50/50 stoichiometric ratio with NO2, thus allowing the oxidation-enabled SCR 120 to proceed with the fast SCR reaction. This “fast SCR” reaction plays a role at 180-300° C. in boosting the denitrification (de-NOx) performance. When diesel is substituted with methanol (or another alcohol fuel) in a lean burn internal combustion engine, a majority of the NOx in the emissions can be in the form of NO2. However, in some examples including when using direct fuel injectors, the exhaust 118 may include both the combustion products (i.e., NO/NOx) as well as secondary exhaust components such as uncombusted secondary fuel 108 and other compounds such as formaldehyde, carbon monoxide, and hydrocarbons.

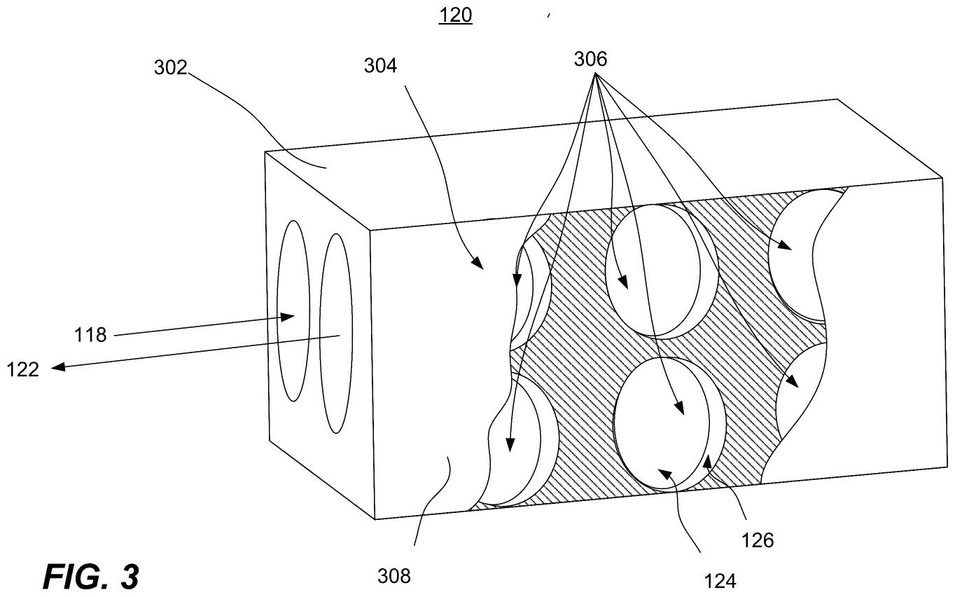

To treat the exhaust 118 for both NO/NOx and the secondary exhaust components, the oxidation-enabled SCR 120 includes a NOx reduction stage 124 and an oxidation stage 126. Although illustrated as being downstream of the NOx reduction stage 124, the oxidation stage 126 may be partially or fully located along one or more locations of a flow path of the exhaust 118 within the oxidation-enabled SCR 120. The NOx reduction stage includes the oxidation-enabled SCR catalysts described above that achieve NOx reduction through Equations 1-3. The oxidation stage 126 oxidizes secondary exhaust components using oxidation catalysts such as, but not limited to, metal zeolite (e.g., copper zeolite). In some examples, the oxidation catalyst can be coated as an undercoat with components such as one or more precious metals. In some examples, the oxidation-enabled SCR 120 includes a first portion that is an extruded matrix, e.g., vanadium with an ammonia slip catalyst, and a second portion that is zone-coated with an oxidation catalyst of precious metal. Some oxidation catalysts include, but are not limited to, platinum, palladium, rhodium, or a monolithic honeycomb substrate coated with a platinum group metal catalyst. Thus, the NOx component of the exhaust 118 is treated in the oxidation-enabled SCR 120 using an NOx reduction catalyst and the secondary exhaust components are treated in the oxidation-enabled SCR 120 using a precious metal oxidation catalyst. In some examples, depending on the materials selected, a portion of the NOx component of the exhaust 118 may also be treated in the oxidation stage 126. An example oxidation-enabled SCR 120 having the NOx reduction stage 124 and the oxidation stage 126 is described in FIG. 3, below.

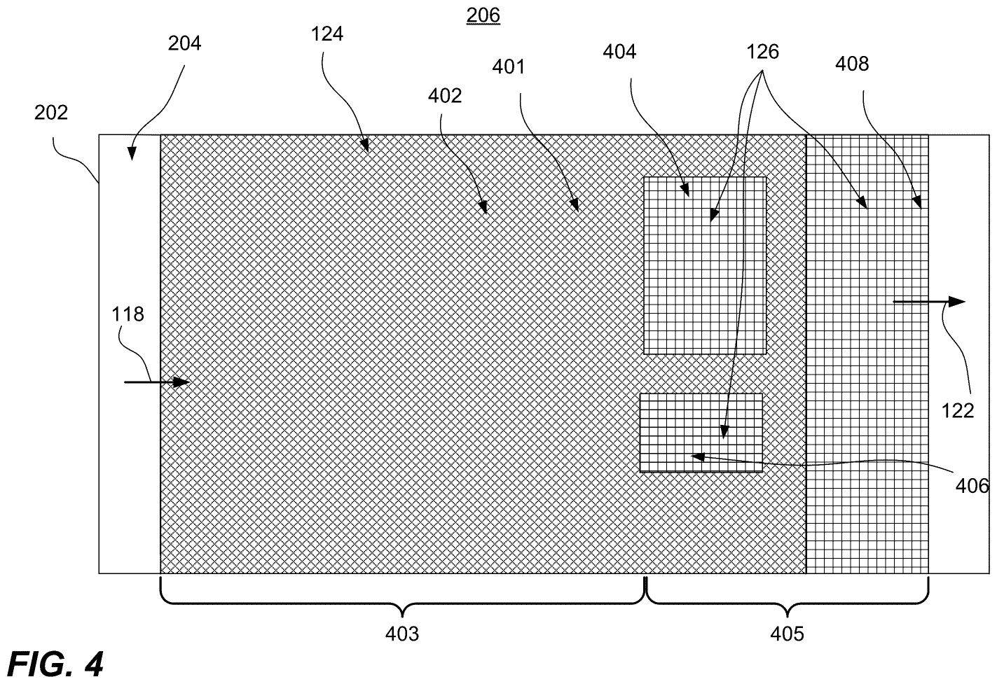

FIG. 3 is a side-view, cutaway illustration of the oxidation-enabled SCR 120 having a catalyst tube with an oxidation layer used to oxidize secondary exhaust components, in accordance with various examples of the presently disclosed subject matter. The oxidation-enabled SCR 120 in FIG. 3 includes an enclosure 302 that encloses a reaction volume 304 within the oxidation-enabled SCR 120. Disposed within the reaction volume 304 of the oxidation-enabled SCR 120 are catalyst tubes 306 (side wall 308 of the enclosure 302 is partially removed to show at least a portion of the catalyst tubes 306). The exhaust 118 enters the enclosure 302 of the oxidation-enabled SCR 120 and flows through the catalyst tubes 306, whereby the NOx in the exhaust 118 is treated in the NOx reduction stage 124 and the secondary exhaust components are oxidized in the oxidation stage 126. It should be noted that in some examples, the oxidation stage 126 may be at the entrance of one or more of the catalyst tubes 306, along the length of one or more of the catalyst tubes 306, and/or near the exit of one or more of the catalyst tubes 306, or various combinations thereof. An example catalyst tube 306 is described in FIG. 4, below.

FIG. 4 is a cross-sectional view of a catalyst tube 306 with the oxidation stage 126 used to oxidize secondary exhaust components, in accordance with various examples of the presently disclosed subject matter. The NOx reduction stage 124 includes a first uncoated area 403 comprising a NOx reduction matrix 402. The NOx reduction matrix 402 is comprised of a catalyst used to reduce NOx within the exhaust 118. The exhaust 118 flows through the NOx reduction matrix 402. The catalyst tube 306 further includes a second area 405 comprising the oxidation stage 126. In some examples, the second area 405 can further include portions of the NOx reduction matrix 402. The oxidation stage 126 includes one or more portions of the oxidation-enabled SCR 120 in which the NOx reduction matrix 402 is either coated with a precious metal oxidation catalyst and/or where the NOx reduction matrix 402 is replaced with the precious metal catalyst. For example, the oxidation stage 126 comprises stage sections 404 and 406. The stage sections 404 and 406 may be sections in which NOx reduction matrix 402 has the oxidation catalyst applied to a portion of the surfaces of the NOx reduction matrix 402. In these areas, i.e., wherein the oxidation coating is applied to portions of the surface of the NOx reduction matrix 402, the exhaust 118 may be treated for NOx in the portions of the stage sections 404 and 406 in which the exhaust 118 is able to travel to the NOx reduction matrix 402 and be treated for the secondary exhaust components in the portions in which the exhaust 118 travels to the oxidation catalyst.

As noted above, portions of the NOx reduction matrix 402 may be replaced by an oxidation catalyst rather than the NOx reduction matrix 402 being coated. For example, stage section 408 may not include the NOx reduction matrix 402. In the volume filled by the stage section 408, the NOx reduction matrix 402 may have been removed or the stage section 408 may have been added to the NOx reduction matrix 402. In the stage section 408, because the catalyst is an oxidation catalyst, the primary treatment may be the oxidation of the secondary exhaust components. However, in some examples, some oxidation catalysts may also reduce NOx levels in the exhaust 118, and thus, may serve a dual purpose of both secondary exhaust product oxidation as well as NOx reduction. Using one or more of the various examples described herein, the exhaust 118 exits the oxidation-enabled SCR 120 as the treated exhaust 122.

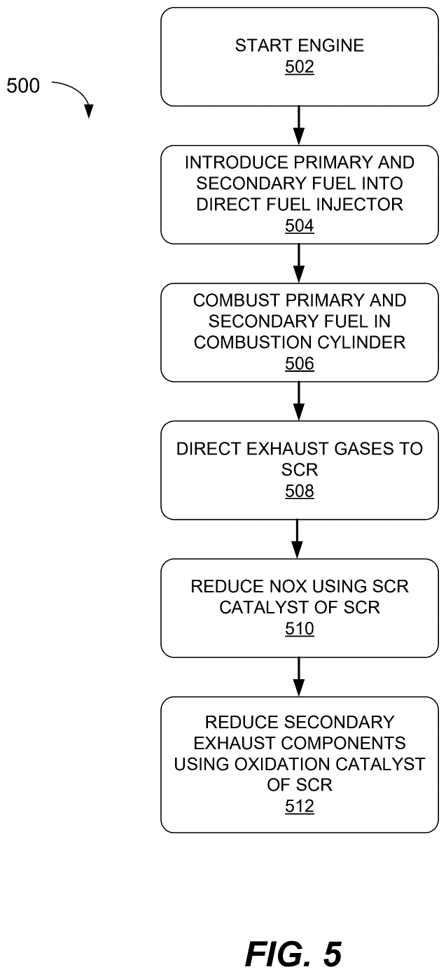

FIG. 5 is a method 500 of using the oxidation-enabled SCR 120 having a catalyst tube 306 with the oxidation stage 126 used to oxidize secondary exhaust components, in accordance with various examples of the presently disclosed subject matter. The order in which the operations are described is not intended to be construed as a limitation, and any number of the described operations can be combined in any order and/or in parallel to implement the processes.

The method 500 commences at step 502, where the engine 102 is started. The engine 102 may be various types of internal combustion engines. In one example, the engine 102 is a diesel-fuel engine that uses an alcohol such as methanol as a secondary fuel. The diesel fuel may be used as a primary fuel and/or as a pilot fuel when the secondary fuel is used.

At step 504, the primary fuel 104 and the secondary fuel 108 is injected into the engine 102 through a fuel injector, such as the direct fuel injector 202 of FIG. 2. In some examples, the primary fuel is used a pilot fuel. As shown in FIG. 2, the fuel load 204 can include a first injected fuel comprising the primary fuel portion 210 followed by the second injected fuel comprising the secondary fuel portion 212. The primary fuel 104 is injected first to commence the combustion process in the cylinder 208, acting as a pilot fuel.

At step 506, the primary fuel and the secondary fuel, comprising the fuel load 204, are combusted in the cylinder 208 of the engine 102. The result of the combustion process is the exhaust 118. The exhaust 118 can include compounds and components such as NO and NOx, as well as, the secondary exhaust components such as uncombusted secondary fuel.

At step 508, the exhaust 118 is directed to the oxidation-enabled SCR 120. The oxidation-enabled SCR 120 is used to treat the exhaust 118 to reduce or remove various components of the exhaust 118 for eventual introduction into the environment around the engine system 100.

At step 510, the exhaust 118 is treated in the NOx reduction stage 124. The NOx reduction stage 124 includes a first uncoated area 403 comprising a NOx reduction matrix 402. The NOx reduction matrix 402 is comprised of a catalyst used to reduce NOx within the exhaust 118.

At step 512, the secondary exhaust components of the exhaust 118 are oxidized in the oxidation stage 126 of the oxidation-enabled SCR 120. The oxidation stage 126 oxidizes secondary exhaust components using oxidation catalysts such as, but not limited to, metal zeolite (e.g., copper zeolite). In some examples, the oxidation-enabled SCR 120 includes a first portion that is an extruded matrix, e.g., vanadium with an ammonia slip catalyst, and a second portion that is zone-coated with an oxidation catalyst of precious metal. Some oxidation catalysts include, but are not limited to, platinum, palladium, and rhodium. In other examples, the first portion is an SCR comprising extruded vanadium, metal zeolite, or other material. In other examples, the SCR comprises a material that is coated. It should be noted that, as described in FIG. 4, above, depending on where the oxidation stage 126 is in the NOx reduction matrix 402, step 510 for portions of the exhaust 118 may occur before, after, or simultaneously with the step 512. Its should be further noted that, in some examples, the oxidation stage may contribute to the a reduction in an amount of NO and NO2 in the exhaust 118 moving through the oxidation-enabled SCR 120.

### INDUSTRIAL APPLICABILITY

The present disclosure relates generally to emission controls for internal combustion engines, primarily diesel fuel engines that use a fuel such as methanol as a substitute fuel for all or a portion of the diesel fuel. The use of methanol (or other fuels similar to methanol) in a diesel engine, including a diesel engine that uses a direct fuel injector, can result in NO/NO2 (NOx) and secondary exhaust product (e.g., uncombusted methanol) in the exhaust. Aspects of the present disclosure use an oxidation-enabled SCR 120. The oxidation-enabled SCR 120 uses a two-stage treatment process within the oxidation-enabled SCR 120. In one stage, the NOx reduction stage 124, NOx combustion products in the exhaust 118 are reduced. In another stage within the oxidation-enabled SCR 120, the oxidation stage 126, secondary exhaust components are reduced. In some examples, the oxidation stage 126 is comprised of portions of the NOx reduction stage 124 that are coated with an oxidation catalyst. In other examples, portions of the NOx reduction stage 124 have been substituted (e.g., removed or replaced) by the oxidation catalyst used in the oxidation stage 126.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. An internal combustion engine system, comprising:
an internal combustion engine configured to combust diesel fuel and a secondary fuel using a direct fuel injector to inject the diesel fuel and the secondary fuel into a cylinder of the internal combustion engine, wherein a portion of an exhaust of the combustion engine comprises nitrogen dioxide (NO2), nitric oxide (NO), and secondary exhaust components, wherein at least a portion of the secondary exhaust components comprise uncombusted secondary fuel;
an oxidation-enabled selective catalyst reactor (SCR) comprising:
a NOx reduction stage comprising an NOx reduction matrix configured to react with and reduce an amount of the NO2 or NO in the exhaust of the internal combustion engine; and
an oxidation stage comprising an oxidation catalyst configured to oxidize and reduce at least a portion of the secondary exhaust components in the exhaust to generate treated exhaust.

2. The internal combustion engine system of claim 1, wherein the secondary fuel comprises methanol, ethanol, n-propyl alcohol, isopropyl alcohol, or t-butyl alcohol.

3. The internal combustion engine system of claim 1, wherein the oxidation catalyst comprises metal zeolite, platinum, palladium, rhodium, or a monolithic honeycomb substrate coated with a platinum group metal catalyst.

4. The internal combustion engine system of claim 1, wherein the oxidation stage comprises the oxidization catalyst coated onto at least a portion of the NOx reduction matrix.

5. The internal combustion engine system of claim 1, wherein portions of the NOx reduction matrix are substituted with the oxidation catalyst.

6. The internal combustion engine system of claim 1, wherein at least a portion of the NO2 is treated in the portions of the NOx reduction matrix coated with the oxidation catalyst.

7. The internal combustion engine system of claim 1, wherein the diesel fuel is used as a pilot fuel.

8. The internal combustion engine system of claim 1, wherein the oxidation-enabled SCR further comprises a plurality of oxidation stages.

9. An oxidation-enabled selective catalyst reactor (SCR) for treating an exhaust of an internal combustion engine using a direct fuel injector to inject a primary fuel and a secondary fuel into a cylinder of the internal combustion engine, the oxidation-enabled SCR comprising:
a NOx reduction stage comprising an NOx reduction matrix configured to react with and reduce an amount of NO2 or NO in an exhaust of the internal combustion engine; and
an oxidation stage comprising an oxidation catalyst configured to oxidize and reduce at least a portion of secondary exhaust components in the exhaust to generate treated exhaust.

10. The oxidation-enabled SCR of claim 9, wherein the secondary fuel comprises methanol, ethanol, n-propyl alcohol, isopropyl alcohol, or t-butyl alcohol.

11. The oxidation-enabled SCR of claim 9, wherein the oxidation catalyst comprises metal zeolite, platinum, palladium, rhodium, or a monolithic honeycomb substrate coated with a platinum group metal catalyst.

12. The oxidation-enabled SCR of claim 9, wherein the oxidation stage comprises the oxidization catalyst coated onto at least a portion of the NOx reduction matrix.

13. The oxidation-enabled SCR of claim 9, wherein portions of the NOx reduction matrix are substituted with the oxidation catalyst.

14. The oxidation-enabled SCR of claim 9, wherein at least a portion of the NO2 is treated in the portions of the NOx reduction matrix coated with the oxidation catalyst.

15. The oxidation-enabled SCR of claim 9, wherein the primary fuel is used as a pilot fuel.

16. The oxidation-enabled SCR of claim 9, further comprising a plurality of oxidation stages.

17. A method of controlling emissions in an exhaust of an internal combustion engine using a direct fuel injector, the method comprising:
directing at least a portion of the exhaust into an NOx reduction stage of an oxidation-enabled selective catalyst reactor (SCR), the NOx reduction stage comprising an NOx reduction matrix configured to react with and reduce an amount of NO2 in the exhaust of the internal combustion engine; and
directing the at least a portion of the exhaust into an oxidation stage of the oxidation-enabled SCR, the oxidation stage comprising an oxidation catalyst configured to oxidize and reduce at least a portion of secondary exhaust components in the at least a portion of the exhaust to generate treated exhaust.

18. The method of claim 17, wherein the secondary exhaust components comprise uncombusted secondary fuel.

19. The method of claim 17, wherein the oxidation catalyst comprises metal zeolite, platinum, palladium, rhodium, or a monolithic honeycomb substrate coated with a platinum group metal catalyst, and wherein the oxidation stage comprises the oxidization catalyst coated onto at least a portion of the NOx reduction matrix.

20. The method of claim 17, further comprising directing the at least a portion of the exhaust into one or more second oxidation stages of the oxidation-enabled SCR.
